(19) United States
(12) Patent Application Publication
(10) Pub. No.: US 2011/0074149 A1
(43) Pub. Date: Mar. 31, 2011

(54) Method and Means for Installing a Union Nut around a Valve Port

(75) Inventors: Sadanori Matsui, Nagahama-shi (JP); Tatsushi Tsunokawa, Nagahama (JP)

(73) Assignee: Matsui Kiki Industries, Ltd., Nigahama (JP)

(21) Appl. No.: 12/891,730

(22) Filed: Sep. 27, 2010

Related U.S. Application Data
(60) Provisional application No. 61/277,555, filed on Sep. 28, 2009.

(51) Int. Cl. F16L 23/00

(52) U.S. Cl. 285/363

(57) ABSTRACT

A union nut is installed over a valve body between an outwardly flaring flange on a valve port and the valve itself. The union nut is uniquely characterized by installation threads cut into an inwardly flaring shoulder, and installation threads are also provided on the flange of the port. The shoulder can be screwed onto the flange until the union nut freely rotates about the port. A split ring is installed against a neck on the port, the neck being adjacent the flange, such that the union nut cannot threadedly engage the installation threads. The freely rotating union nut can be tightened into a suitable fitting that is part of a fluid system.

### RELATED U.S. APPLICATION DATA

This application claims the benefit of priority of U.S. Provisional Application No. 61/277,555, filed on Sep. 28, 2009, and titled “Method and Means for Installing a Union Nut around a Valve Port”, incorporated herein by reference in its entirety.

### BACKGROUND OF THE INVENTION

Valve assemblies used to connect and control the flow of fluid through tubular members are characterized by one or more valves operable in a valve body. Compression fittings, friction fittings, direct thread couplers, potted joints, and flanged couplers are a few of the more common methods used to connect various components of a fluid system. Because some tubular members, such as pipes, are often unable to be rotated relative to a valve body, there are not many acceptable methods for removably joining a valve assembly to tubular members.

A union nut, which spins freely against an outwardly flaring flange of a tubular member, is an acceptable way to connect to a male threaded port. The union nut is installed against the flange by sliding the union nut over a free end of the tubular member. The union nut can then be used to tighten the flanged end of the tubular member against a threaded port on a valve body. If it desired to have an outwardly flaring flange on the port, rather than on the tubular member, a split union nut can be used. Other alternative solutions to this problem include pressing, welding, crimping or flaring the end of a port after the union nut is installed. There is a need for a strong and simple way to install a union nut over a flanged port of a valve body or fitting that is large relative to the union nut.

### SUMMARY OF THE INVENTION

The present invention is a method and means for installing a union nut between an outwardly flaring flange on a port and an obstacle, such as a valve. In the most preferred embodiment, the union nut is uniquely characterized by installation threads cut into an inwardly flaring shoulder, and installation threads are also provided on the flange of the port. The shoulder can be screwed onto the flange until the union nut freely rotates about the port. A split ring is installed against a neck on the port, the neck being adjacent the flange, such that the union nut cannot threadedly engage the installation threads. The freely rotating union nut can be tightened into a suitable fitting that is part of a fluid system.

### BRIEF DESCRIPTION OF THE DRAWINGS

FIG. 1 is a perspective view of a valve assembly incorporating a union nut of the present invention.

FIG. 2 is a cross sectional view through line 2-2 of FIG. 1.

FIG. 3 is a cross sectional view through line 3-3 of FIG. 1.

FIG. 4 is an exploded perspective view of the union in FIG. 1.

FIG. 5 is a perspective view showing the union nut being installed on the port.

FIG. 6 is a perspective view showing the union nut installed on the port.

FIG. 7 is a perspective view showing the split ring being installed on the port.

FIG. 8 is a perspective view showing the union nut being threaded onto an adapter.

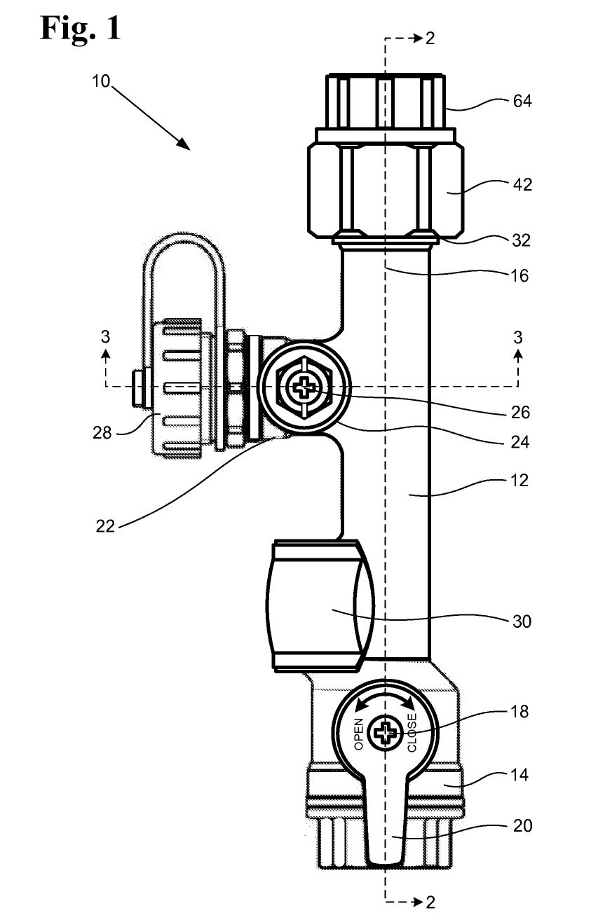

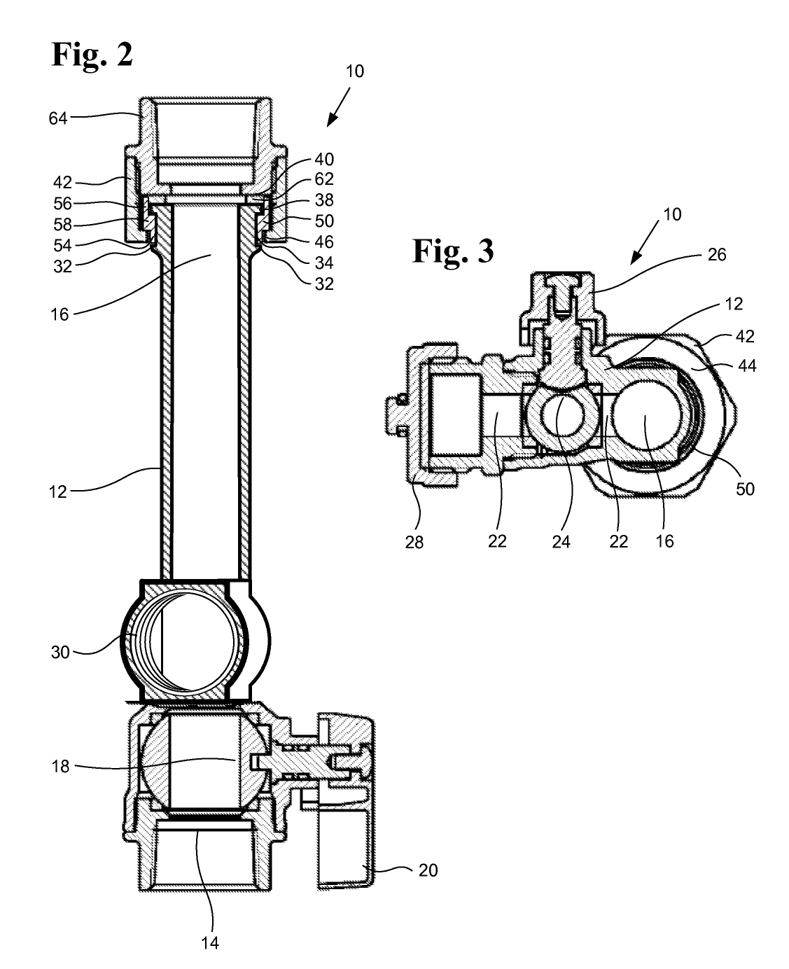

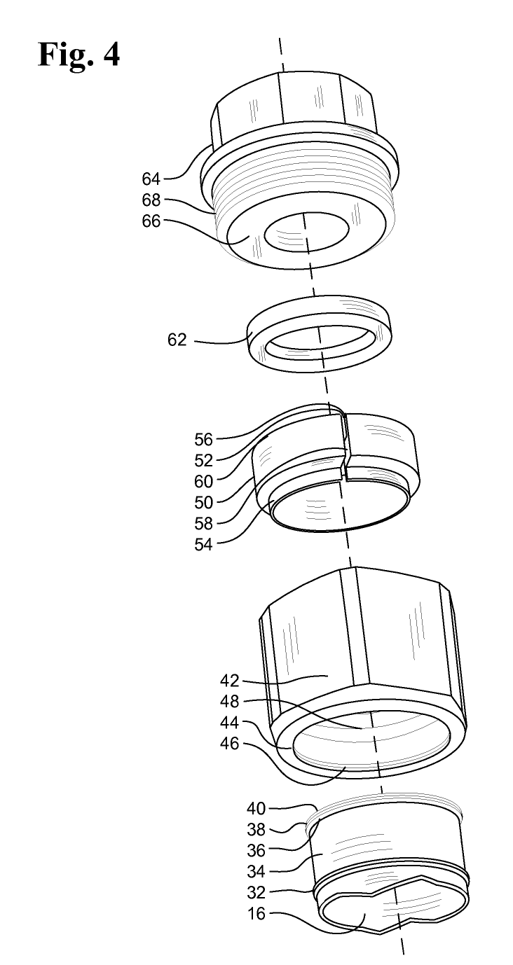

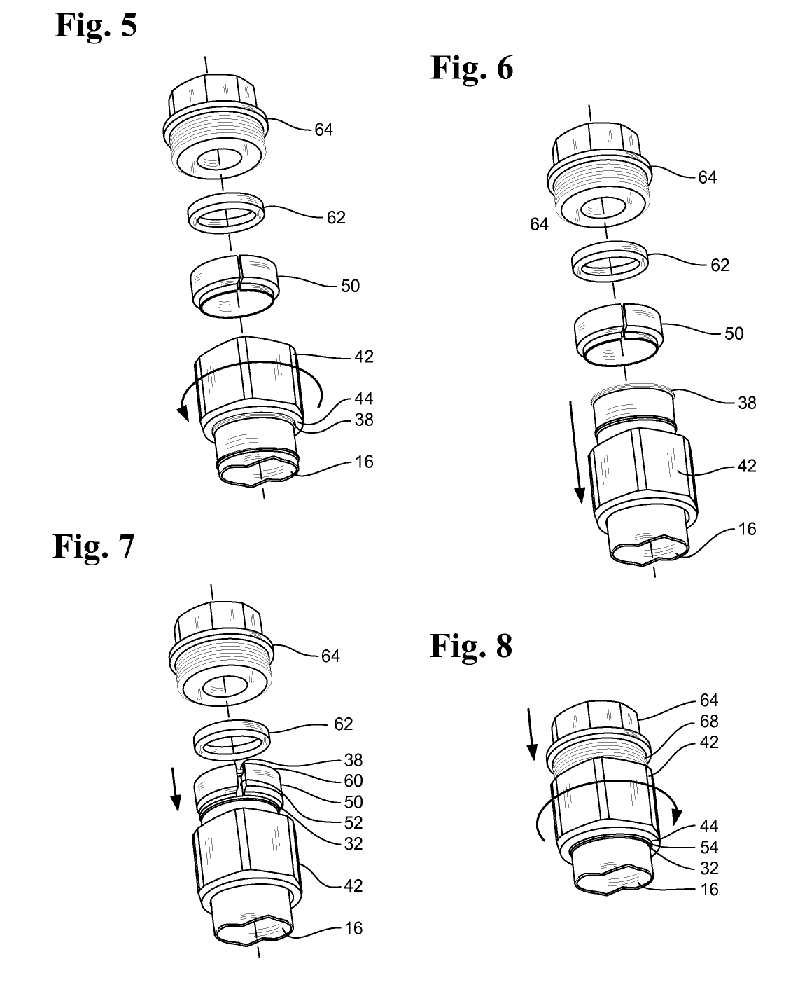

The following is the list of numerical callouts used in FIGS. 1-11:
10. Valve assembly
12. Casing
14. First port
16. Second port
18. Main valve
20. Main handle
22. Third port
24. Drain valve
26. Drain handle
28. Safety cap
30. Fourth port
32. Ridge
34. Neck
36. Flange
38. Male Installation Threads
40. First Seat
42. Union Nut
44. Shoulder
46. Female Installation Threads
48. Female Union Threads
50. Split Ring
52. Split
54. Inner cylindrical sleeve portion
56. Outer cylindrical sleeve portion
58. Middle cylindrical sleeve portion
60. Rim
62. Washer
64. Adapter
66. Second Seat
68. Male Union Threads

### DETAILED DESCRIPTION OF THE INVENTION

This detailed description will begin by describing the relevant components of a valve assembly that incorporates the present invention, followed by a description of the features of a port, and then the various coupler components in the order that they are installed onto the valve assembly. Where reference numbers in one figure are the same as another figure, those reference numbers carry substantially the same meaning Preferred sizes, materials and methods of attachment will be discussed, but these preferences are not intended to exclude other suitable or functionally equivalent sizes, materials or methods of attachment.

A valve assembly 10 has a casing 12 that encases at least one valve for selectively opening or obstructing the flow of fluid through a pathway. The casing, which includes the entire valve body, is characterized by a main pathway for connecting a primary inlet to a primary outlet for the flow of a fluid through the valve assembly. The main pathway is preferably the least restrictive path through and between the largest ports, or main ports, of the valve assembly. Other secondary ports frequently branch off of the main pathway at an angle, such as 90 degrees. All of these ports are part of the valve body. The casing can be formed from any known suitable material, such as metals or plastics, that meet the demands of a particular application. When used to service water pipes, the casing is preferably cast brass to allow the valve assembly to be compatible with numerous common pipe materials without creating an electric potential that causes corrosion.

A first port 14, herein arbitrarily defined as a main port that is closest to the main valve of the valve assembly, is either an inlet or an outlet, depending on the direction of fluid flow. On a tankless water heater application, the first port of the cold water valve assembly is preferably an inlet connected to a water supply, while the first port of the hot water valve assembly is preferably an outlet connected to a faucet. The first port can terminate, at its open end, with a common connection means, such as male or female threads or a socket type connection.

A second port 16 is preferably a main port that is either an outlet or an inlet. The main valve 18, which is intermediate the first port and the second port, is characterized by a valve member, such as a ball having a passageway that can be rotated. The valve member, which can open or obstruct the flow of a fluid through the valve body, is controlled by rotating a main handle 20 that turns a stem that passes through a bonnet in the casing and directly connects to the valve member. The main handle is preferably large enough to provide adequate leverage such that a user can rotate the main handle without requiring the use of any tools. A lever or T-handle is preferred. If a fluid system is equipped with more than one valve assembly, color coded valve handles will allow a user to quickly distinguish fluid flow and fluid characteristics, such as red for hot and blue for cold. Familiar ON/OFF arrows are also beneficial.

A third port 22, optional, can be incorporated into a valve body to provide access to a fluid system for service or maintenance by a user. On tankless water heater applications, the third port protrudes perpendicularly from the main pathway through the valve body intermediate the main valve and the second port. A drain valve 24 controls the flow through the third port. The third port is preferably smaller than the main ports to allow for the use of a smaller drain valve such that the perpendicularly projecting third port and drain valve don't significantly contribute to the overall size of a valve assembly. The drain valve should only be open during servicing of the fluid system. A drain handle 26 of the drain valve preferably has a smaller profile that offers little leverage to a user, so it is very difficult to manipulate the drain valve's valve member without a tool, such as a wrench. A small hexagonal drain handle, which may also be slotted, is preferred. Opening the drain valve can cause fluid to spray onto a user, especially an unintended user, who is unaware of the potential harm the fluid could cause to property or persons. Making the drain handle obviously different from the main handle should help prevent someone from accidentally opening the drain port. A safety cap 28 is additionally used to protect the drain port from dirt that may damage valve components, from leaking and from being accidentally opened. Collectively, the smaller sized third port, drain valve and drain handle make for easier installations and safer access for servicing a system that utilizes the valve assembly.

A fourth port 30, optional, usually branching off of the main pathway somewhere between the main valve and the second port, can be provided to allow a pressure relief valve (not shown) to be installed onto the valve assembly. Pressure relief valves are usually not needed on a cold water valve because cold water supplies are expected to operate within a safe range of pressures. Additional or alternate ports, most commonly outlets, can be incorporated onto a valve body as needed. Any suitable connection means can be formed or installed at an open end of any of the ports.

Most preferably, at least the second port of the above described valve assembly has a rotatable union nut installed over the port, without requiring the use of any tools. Brass, which is the preferred material for forming the valve casing, is cast, forged and/or machined to produce a desired shape. Unlike some other materials, it is not effective to try to flare or crimp the open end of a brass port to secure a union nut over the port such that the union nut rotates freely and can be threaded into a male fitting to be connected to the valve assembly. Instead, the following description explains how to make and install a rotatable union nut on a valve port.

A ridge 32 is formed around the exterior of a port such that a neck 34 is defined near the open end of the port. The neck is preferably machined, along with the other features described in this paragraph, such that a cast part that has not yet been machined probably is not characterized by any of these features. Adjacent the open end of the port is an outwardly flaring flange 36, characterized by a larger diameter than at least the neck and ridge, formed to include male installation threads 38. The male installation threads are preferably just a few projecting helical ribs having a fine pitch. It should be noted that the ridge and flange probably are not defined until after the neck has been machined into the port. The open end of the port terminates at a first seat 40 that has a flat and smooth face.

A union nut 42 is preferably made of brass, but it could also be copper, steel, iron or other metal that is compatible with a material being joined to, or it could be plastic, such as PVC. The union nut has an inwardly flaring shoulder 44 characterized by female installation threads 46 that are cut into the inner-most diameter of the shoulder. The diameter of the shoulder is too small to slip over the port on the valve body unless the female installation threads are screwed onto the male installation threads on the flange of the port. After several turns, the shoulder of the union nut is completely threaded over the flange of the port until the union nut freely slips past the neck and ridge on the port, no longer in threaded engagement. As is more common, the union nut is multi-sided, such as a hexagon, and characterized by female union threads 48. The nominal diameter hole of the union nut is greater than the largest diameter of the shoulder, so the female union threads easily slide over the flange on the port.

After sliding the union nut over the port, a split ring 50 is installed around the neck of the port. The split ring is preferably a dielectric material, such as a strong plastic. The split ring is formed as two or three concentric offset cylindrical sleeves that do not have a continuous circumference because there is a split 52 that allows the split ring to be opened into a larger circumference. While the split ring is opened, it can pass over the flange on the port until it is positioned around the neck. Releasing the split ring will cause it to close around the neck such that an inner cylindrical sleeve portion 54 lies between the ridge and the flange of the port. An outer cylindrical sleeve portion 56 of the split ring partially covers the inner cylindrical sleeve portion, and fully covers the male installation threads on the port. A middle cylindrical sleeve portion 58, if needed, joins the inner and outer cylindrical sleeve portions. With the split ring installed, the union nut can be partially drawn over the split ring until the shoulder of the union nut abuts an end of the outer cylindrical sleeve portion, against which the union nut can freely rotate. The shoulder is centered about the port by the inner cylindrical sleeve portion, which also serves to prevent the union nut from coming into electrical contact with the valve casing.

A washer 62, most preferably made from rubber or other similar flexible material, is installed against the first seat 40. The outer cylindrical sleeve portion of the split ring can extend beyond the end of the port such that a rim 60 can be used to centrally align the outer diameter of the washer. The inner diameter of the washer should be approximately the same size as the fluid pathway at the end of the port.

An adapter 64, which is preferably made from a compatible or similar material as the union nut, is characterized by a second seat 66 that is positioned against the washer. The union nut can then be screwed to male union threads 68 on the adapter until the first and second seats are tightened against the washer. The other end of the adapter can be any desired connection means, such as a threaded connection or socket connection.

Although the above description focused on how to install the preferred union nut onto the second port of a valve assembly, the union nut can similarly be installed onto a port that is part of a fitting, such as a tee, Y, cross or elbow fitting, that cannot accept a common union nut because both ends of the port have physical barriers. For example, the intersection of the ports of a tee fitting present an obvious physical barrier on one end of a port, and the flange presents a physical barrier on the open end of a port that should include a union nut. By forming male installation threads onto the flange of a port, the union nut and split ring already discussed can be installed onto a port of a tee fitting.

A first alternate embodiment uses left-handed installation threads on the flange of the port and on the shoulder of the union nut. After the union nut is installed onto the port, the right-handed union threads on the union nut and the adapter can be screwed together without needing a split ring. A washer, or other sealing means, is still needed. The installation threads will not engage when the union nut is being turned the wrong way, so the union can be tightened directly against the leading left-handed installation threads. Appropriate guides should be provided between the shoulder and the union threads of the union nut to centrally align the union nut around the port. A consideration is that, in the preferred embodiment, the split ring functioned as a dielectric. The port and/or union nut can be plastic, such as PVC, which would eliminate the need for a dielectric union.

A second alternate embodiment, not shown, is substantially similar to the preferred embodiment, except there are no installation threads. Instead, the diameter of the shoulder of the union nut is only slightly larger than the outer diameter of the flange of the port, so union nut can be installed over the port. The split ring, which will also function to prevent the union not from slipping off the port, must be strong enough to withstand the additional linear forces exerted against the coupler when the union nut is tightened against a fitting.

While a preferred form of the invention has been shown and described, it will be realized that alterations and modifications may be made thereto without departing from the scope of the following claims.

What is claimed is:

1. A union, for connecting to a tubular member of a fluid system, comprising:
a union nut having union threads;
an inwardly flaring shoulder on the union nut, the shoulder characterized by female installation threads;
a port having a neck and a first seat;
a fitting having a second seat;
an outwardly flaring flange on the port, the flange characterized by male installation threads; and
wherein the pitch and diameter of the female installation threads allows the shoulder to threadedly engage the male installation threads such that the union nut can be installed over the port.

2. The union of claim 1 wherein the port is integral to a casing of a first valve assembly.

3. The union of claim 1 wherein the union threads are characterized by right-handed threads, and wherein the male and female installation threads are characterized by left-handed threads.

4. The union of claim 3 wherein a portion of the male and female installation threads can abut each other without becoming threadedly engaged.

5. The union of claim 1 further comprising a split ring that is capable of being installed around the neck of the port.

6. The union of claim 4 wherein the split ring is made from a material that acts as a dielectric.

7. The union of claim 1 wherein the fitting is an adapter.

8. The union of claim 2 wherein the fitting connects to a tankless water heater such that the first valve assembly controls a cold water supply for the tankless water heater.

9. The union of claim 8 further comprising a second valve assembly, that connects to a hot water outlet of the tankless water heater, characterized by a second union that is substantially similar to the union on claim 1.

10. A union, for connecting to a tubular member of a fluid system, comprising:
a union nut characterized by an inwardly flaring shoulder;
a port characterized by an outwardly flaring flange, a neck and a first seat;
a fitting characterized by a second seat; and
a split ring that can be installed around the neck.

11. The union of claim 10 wherein the split ring is a single piece part characterized by two offset cylindrical sleeve portions that are substantially concentric.

12. The union of claim 11 wherein the port is part of a casing of a valve assembly.

13. The union of claim 11 further comprising a third cylindrical sleeve portion that is intermediate the two offset cylindrical sleeve portions.

14. The union of claim 11 wherein the shoulder and flange are characterized by installation threads.

15. The union of claim 11 wherein an inner diameter of the shoulder is only slightly larger than an outer diameter of the flange.

16. The union of claim 15 further comprising a third cylindrical sleeve portion that is intermediate the two offset cylindrical sleeve portions.

17. A method for installing a union nut over a port comprising the steps of:
manipulating a shoulder portion of the union nut past a flange portion of the port;
installing a split ring at least partially around a neck portion of the port and around the flange portion; and
drawing the union nut over the split ring until the shoulder portion is adjacent the split ring.

18. The method of claim 17 wherein the step of manipulating is characterized by screwing installation threads on the shoulder over installation threads on the flange.

19. The method of claim 17 further comprising the step of manipulating the shoulder portion past a neck portion of the port.

20. The method of claim 17 further comprising the steps of:
positioning a washer adjacent an end of the port such that an overlapping portion of the split ring centrally aligns the washer; and
tightening the union nut to a fitting that creates a seal with the washer.
